(19) United States
(12) Patent Application Publication
(10) Pub. No.: US 2002/0026533 A1
(43) Pub. Date: Feb. 28, 2002

(54) System and method for distributed control of unrelated devices and programs

(76) Inventors: Prabal K. Dutta, Columbus, OH (US); Charles E. McManis, Sunnyvale, CA (US)

Correspondence Address: PENNIE & EDMONDS LLP, COUNSELLORS AT LAW, 3300 Hillview Avenue, Palo Alto, CA, 94304, US

(21) Appl. No.: 09/760,332

(22) Filed: Jan. 12, 2001

Related U.S. Application Data
(60) Provisional application No. 60/176,018, filed on Jan. 14, 2000.

(51) Int. Cl. G06F 9/46

(52) U.S. Cl. 709/313

(57) ABSTRACT

A distributed computer system includes a number of microcontrollers adapted into a common architecture neutral network, aggregated by a hierarchy of software engines that provide both connectivity and semantic translation via network servers. The network servers are connected through the network, using architecture neutral command and control programs. A number of first entities are configured to generate a plurality of first messages in a first communication protocol, and a first adapter is configured to convert the first messages of the first protocol to a second communication protocol. A second entity coupled to the first entities is configured to communicate via the first entities via a first adapter, and a third entity, configured to receive the first messages from the first entities, is configured to generate a second message based on the received first messages.

This application claims priority on U.S. provisional patent application serial No. 60/176,018, filed Jan. 14, 2000, hereby incorporated by reference.

### FIELD OF THE INVENTION

The present invention relates to a system and method of aggregating devices originally designed and implemented to perform a limited range of tasks in a system of connected devices cooperating with each other, to thereby provide a wide variety of enhanced features and services.

### BACKGROUND OF THE INVENTION

Embedded devices are computers or microchip-based control devices that are dedicated to perform specific tasks or groups of tasks. Embedded systems are utilized in a variety of industrial and consumer products, including disk drives in computers, automated teller machines at banks, various switching devices, temperature controllers for home appliances such as refrigerators and ovens, as well as many other types of products.

Software applications are computer programs such as databases, Enterprise Resource Planning (ERP) packages, billing systems and other business software applications.

The above mentioned embedded devices and software applications are conventionally not implemented to interoperate with each other. However, a number of recent technological developments are making the interoperation among the disparate devices and applications a possibility. First, the Hyper Text Transfer Protocol (HTTP) provides a standard way formatting information so that it can be displayed using a browser program. Second, high integration microprocessors allow a significant amount of computing power to be applied to a specific problem. Third, architecture neutral languages, such as Java from Sun Microsystems, and standardized object resource broker (ORB) interfaces make it possible to write programs that run on a wide variety of platforms.

However, no conventional system utilizes the currently available technology to provide a system or method of combining existing embedded devices and legacy software applications into one system that produces greater utility than the individual components.

### SUMMARY OF THE INVENTION

The present invention provides a distributed computer system including a number of microcontrollers adapted into a common “architecture neutral” network, aggregated by a hierarchy of software engines that provide both connectivity and semantic translation via network servers. The network servers are connected through the network, using architecture neutral command and control programs.

In the present invention, a number of first entities are configured to generate a plurality of first messages in a first communication protocol, and a first adapter is configured to convert the first messages of the first protocol to a second communication protocol. A second entity coupled to the first entities is configured to communicate via the first entities via a first adapter, and a third entity, configured to receive the first messages from the first entities, is configured to generate a second message based on the received first messages.

### BRIEF DESCRIPTION OF THE DRAWINGS

Preferred features of the present invention are disclosed in the accompanying drawings, wherein similar reference characters denote similar elements throughout the several views, and wherein:

FIG. 1 is an illustration of a standard configuration of the present invention;

FIG. 2 is an illustration of an integrated NetClient and NetRouter configuration of the present invention;

FIG. 3 is an illustration of another integrated NetObject and NetRouter configuration of the present invention;

FIG. 4 is an illustration of a Network- and Transport-independent Peer-to-Peer communication configuration of the present invention;

FIG. 5 is an illustration of a Network- and Transport-independent Multicast Peer-to-Peer communication configuration of the present invention;

FIG. 6 is an illustration of a NetConnet Dial-up Access configuration of the present invention; FIG. 7 is an illustration of an alternate NetClients configuration of the present invention;

FIG. 8 is an illustration of a network using multiple transport mechanisms for connecting NetObjects to a NetRouter.

FIG. 9 is an illustration of an overall internal software architecture of the present invention;

FIG. 10 is an illustration of an automatically generated HTML user interface of the X-10 system implementation of the present invention;

FIG. 11 is a block diagram of a client computer;

FIG. 12 is a block diagram of a server computer in accordance with a preferred embodiment of the present invention; and

FIG. 13 is a block diagram of a legacy device in accordance with a preferred embodiment of the present invention.

### DETAILED DESCRIPTION OF THE PREFERRED EMBODIMENTS

A preferred embodiment of the present invention is called a NetConnect™ (a trademark of NetEnabled.Com) system. A NetConnect system generally includes three types of components: network objects (NetObjects), client software (NetClient) executed by client devices, and server software (NetRouter) executed by server computers.

A NetObject is an electronic device or embedded system. A NetObject is conceptually similar to an object from object-oriented programming. For instance, a NetObject is represented as a set of fields (properties), methods (functions) and events. NetObjects can be created for both legacy devices and new devices. As will explained below, NetConnect supports hybrid devices and network interoperability.

A NetObject can communicate with another NetObject by reading and writing its fields and invoking its methods. Each NetObject also supports network-and transport-independent peer-to-peer communications. Both new and legacy NetObjects from different manufacturers, located on the same or different proprietary networks, can communicate with each other through a technique known as Event-to-Method binding. Exemplary NetObjects include:

Energy management NetObjects, including NetObjects for utility meters and HVAC controllers;

NetObjects for microcontroller evaluation boards;

NetObjects for Automobiles and various automobile subsystems;

NetObjects for Security systems; and

NetObjects for X10 home control modules.

A NetClient is a client interface that allows its users to access, configure and manage a set of NetObjects. A NetClient can be implemented on practically any client platform or device. The exposed fields and methods of a NetObject can be accessed from NetClient software programs written in C, C++, Visual Basic, Java, or any other language that supports network communications. Exemplary NetClients include:

Web browsers;

Java applets;

PDAs (Palm Pilots, Windows CE H/PC);

Telephones;

Pagers; and

Spreadsheet software programs (e.g., Excel).

A NetRouter is server software that provides routing services between two NetObjects or a NetObject and a NetClient. In a preferred embodiment, NetRouters run in any Java-enabled execution environment. In other embodiments NetRouters can be designed to work in other architecture neutral execution environments. NetRouters can also communicate with other NetRouters using encrypted TCP/IP protocols, thereby securely extending the reach of the embedded network. NetRouters also provide a network application execution environment. A NetRouter may include a number of components, for example:

an HTTP server with Java Serviet support;

an application server with Java and JavaScript support;

e-mail, database and telephony gateways;

event subscription and publication services; and/or

network drivers for interfacing to various networks.

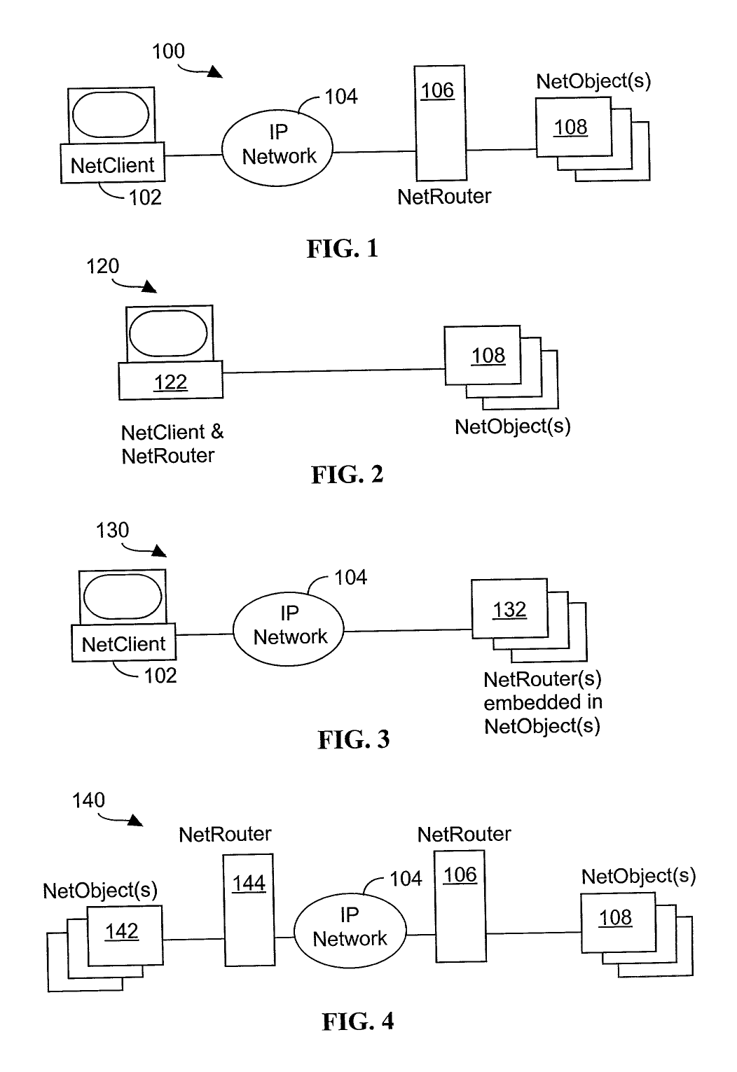

A NetConnect system can be adapted to a number of different configurations to suit most device-networking requirements. The following examples serve to illustrate the number and type of different configurations that can be implemented using the NetConnect system. Referring to FIG. 1, a system 100 based on a standard configuration of the NetConnect embodiment of the present invention supports a number of different NetClients 102 (user interfaces) such as a web browser, spreadsheet, command-line interface, custom program, billing system or database. These NetClients 102 communicate over any TCP/IP network 104 with the NetRouter 106, which then communicates with the NetObjects 108 to fulfill the requests.

A typical use of the standard system configuration of FIG. 1 is accessing process control data (e.g., measurements generated by on-site sensors) in real-time via a spreadsheet executed by a client computer that is remotely located from the location at which the process control data is physically accessible. It makes no difference whether the client computer, having the NetClient software, is located a half mile or thousands of miles away from the physical plant whose data is being accessed.

Another typical use of the standard system configuration of FIG. 1 is controlling environmental and security systems from a central location. In this example, the client computer executing the NetClient executes a software application for generating environmental control commands or security system control commands. The commands are routed through a network, through the NetRouter, to the NetObjects, which implement the commands.

Yet another typical use of the standard system configuration of FIG. 1 is performing automated preventative diagnostics on remote embedded systems. In other words, the NetClient software receives information from the NetObjects in remote embedded systems, and performs automated preventative diagnostics using the received information.

### Integrated NetClient and NetRouter

Referring to FIG. 2, a system 120 that is based on an Integrated NetClient and NetRouter 122 configuration of the present invention is ideal for traveling technicians, or for local operation without the Internet. This configuration puts both the NetRouter and the NetClient on the same machine.

Typical uses for this configuration include: (A) engineering development during which time the device (including the NetObject) and software (including the NetClient) under development are directly connected; (B) allowing a non-network device to communicate with a NetObject; and (C) providing backup or redundant local access to a network device (having a NetObject).

### Integrated NetObject and NetRouter

Referring to FIG. 3, a system 130 using an Integrated NetObject and NetRouter 132 of the present invention is ideal for stand-alone network devices. By integrating the NetRouter into the NetObject, a network device such as a hub, bridge, switch, router, UPS or other network node can participate in the NetConnect execution environment without requiring a host PC or server.

Typical uses for this configuration include: (A) an uninterruptable power supply can be “network enabled”(by including both a NetObject and NetRouter) so that it can inform the system administrator of its load profile and remaining power; (B) a third-party server hosts a NetRouter, enabling it to bridge both its proprietary networks and NetConnect networks; and (C) a home automation control center is built around a ‘black box’ containing a NetRouter.

### Network- and Transport-independent Peer to Peer Communications

FIG. 4 shows another embodiment of the present invention, a network- and transport-independent peer-to-peer communications system 140 that enables two devices (represented by NetObjects 108 and 142), from two different manufacturers, operating on the same or different networks, to communicate with each other, via NetRouters 106 and 144 and a communications network 104. Through the use of routing tables and Event-to-Method bindings, events on one device can trigger actions on another device (located practically anywhere else in the world).

Typical uses of this configuration include: (A) a joystick in one location controls a camera in a different location, eliminating the need to physically locate a human near every camera; and (B) an intruder alarm in one part of a building turns on lights and alarms throughout the entire building (the alarm sensors and security control system can utilize different network and transport protocols, because the NetRouters convert all communications to a protocol shared by the NetRouters).

### Network- and Transport-independent Multicast Peer to Peer Communications

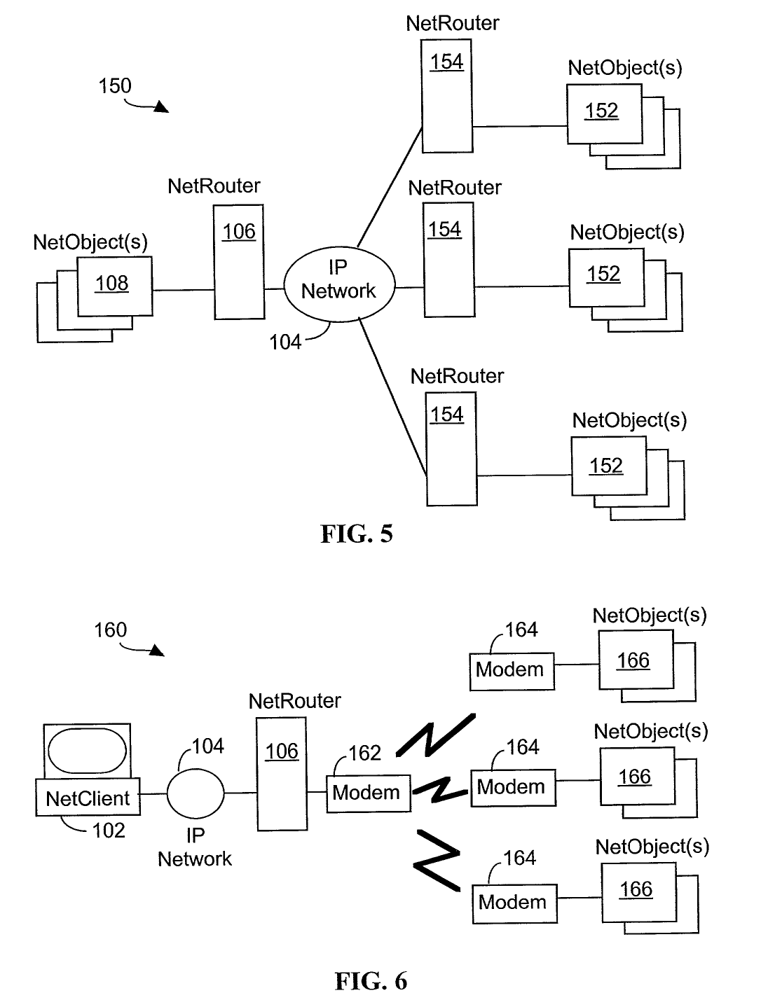

Referring to FIG. 5, a network- and transport-independent multicast peer-to-peer communications system configuration 150 of the present invention is ideal for scenarios where one event triggers a number of different responses simultaneously (or almost simultaneously). This configuration uses a publication/subscription model of interaction, where NetObjects 108 publish their events to a network 104 (via a NetRouter 106), and other NetObjects 152 can subscribe to these events at the appropriate NetRouter. The subscribing NetObjects 152 receive event messages published to the network 104 via NetRouters 154.

An example of this configuration is the following exemplary security system: (A) a motion sensor is tripped causing an event publication; (B) a siren and floodlights have subscribed to the motion sensor's trip event, and are automatically turned on, via the Event-to-Method binding mechanism; (C) a telephone device also subscribes to the motion sensor's trip event, and automatically makes a phone call to the local police department, alerting them of the tripped motion sensor, and (D) a e-mail application also subscribes to the motion sensor's trip event, and sends a short e-mail to the homeowner's pager, informing him of the alarm. Thus, in this example, several classes or types of devices (NetObjects) subscribe to a motion sensor's trip event, thereby implementing multicast peer-to-peer communications.

### NetConnect Dial-up Access

Referring to FIG. 6, a NetConnect dial-up access configuration 160 of the present invention is a preferred way to communicate with devices 166 located in remote sites or connected phone lines via a NetRouter 106 coupled to the NetClient 102 by an network 104 and coupled to the legacy devices 166 via modems 162 and 164. The modems 162, 164 are typically interconnected by the public switched telephone network (PSTN). Examples of such devices include automatic meter readers (AMR), security systems, credit card machines, remote diagnostics, and telemetry.

Another example is a sub-metering application, where a single phone line connects to a modem-enabled master meter, and dozens of sub-meters are connected to the master meter using an existing network. In this model, an ISP would host a NetRouter that would call out to the master meter to acquire meter usage data. If the Internet Service Provider and meter were located in the same area code, long-distance toll charges would be minimized or eliminated.

From the viewpoint of end users, primary benefits of the NetConnect system configurations and methodology for interconnecting devices and applications, many of which would otherwise be incompatible with each other, include:

the system is inexpensive to implement, both in terms of up-front capital cost and cost per device;

the system is highly scalable;

the system provides regional, national or international coverage without having to make any special provisions for such wide coverage;

communications are encrypted and authenticated (i.e., the shared protocol of the NetRouters preferably uses encrypted, authenticated communications);

uniform service cost for each point;

uniform cost of installation for each device;

units can be deployed rapidly without setting up data centers or other local infrastructure;

low costs and reduced network downtime can be achieved by outsourcing end-to-end network management;

rapid installation and deployment—often installation requires only adding a phone line to a device;

easy, low cost removal when portions of a system need to be decommissioned.

The Internet Service Provider benefits from this configuration as well. From the viewpoint of Internet Service Providers (ISPs), primary benefits of the NetConnect system configuration and methodology for interconnecting devices and applications, include:

subscribers can be devices as well as people;

the system enables the use of new business models and the generation of new revenue streams;

the system allows improved capacity utilization and revenue realization during off-peak hours; and

the IPS's fixed costs can be amortized over more customers.

Referring to FIG. 7, a NetConnet system 170 can also use alternative user interfaces such as pagers 171,PDAs 172, telephones 173, custom software applications, and the like. Different user interfaces are appropriate for different tasks. For example, it may be easier to instruct a house to turn on its air conditioner via a phone call or pager rather than a web browser. The devices incorporating the user interfaces are preferably coupled to a NetRouter 175 via an IP network 104 or the public switched telephone network 174. The NetRouter 175 in turn is coupled to one or more NetObjects 108.

Typical uses for alternate NetClients include:

a user calling up his/her house and checking the temperature from a telephone the same way he/she checks for voice mail today;

a pager notifying the user when the service repairman arrives, and when the repairman leaves, so that the user can rest assured that his/her bill is accurate;

unlocking a car from the user's PDA, just by sending an e-mail message with the user's user name and secret password; and/or

service technicians can call up devices over the phone or through their PDAs when booting a laptop just isn't convenient.

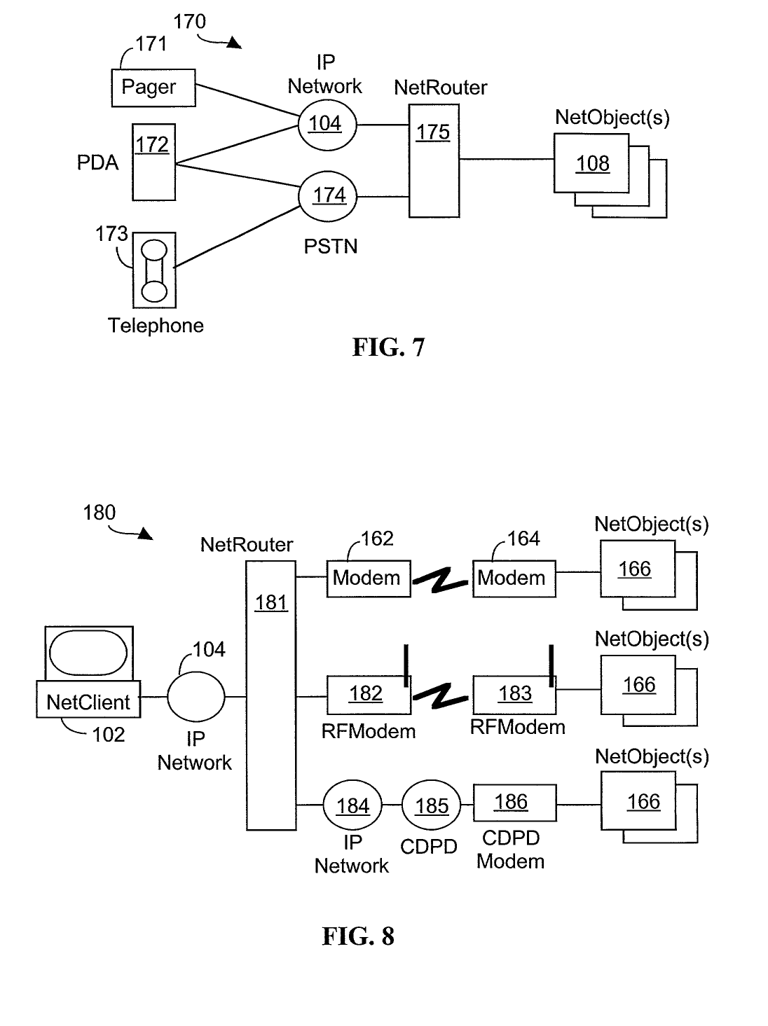

Referring to FIG. 8, there is shown a system 180 having an alternate network and set of transport mechanisms for connecting NetObjects 166 to a NetRouter 181. In particular, in this exemplary system some NetObjects are coupled to the NetRouter 181 by telephone line modems 162, 164, some NetObjects are coupled to the NetRouter 181 by wireless (e.g., RF) modems 182, 183, and yet other NetObjects are coupled to the NetRouter 181 by an IP network 184 coupled to a Cellular Digital Packet Data (CDPD) network 185, which is in turn coupled to one or more NetOjbects 166 by a CDPD modem 186. The components of the system remain network- and transport-independent, allowing a user to choose whichever network and transport protocol(s) best meet the user's wide-area communications needs. NetConnect messages can be transmitted over virtually any physical media, such as modems, CDPD modems, RF, IrDA, and the like. This way, practically any device can be incorporated into a NetConnect system.

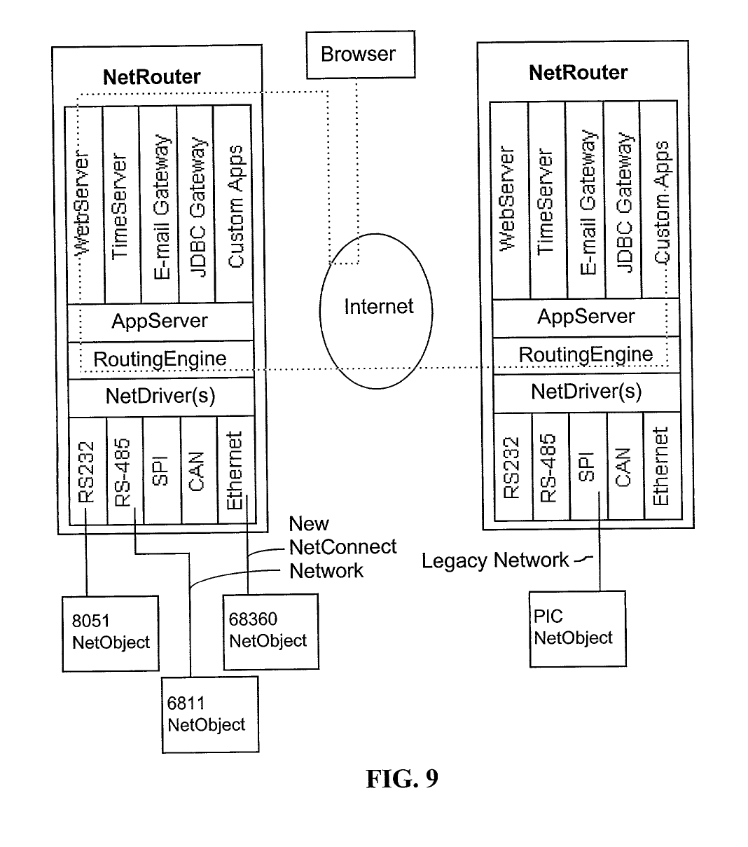

Now referring to FIG. 9, an exemplary method to connect a legacy device, an X-10 device, is illustrated.

As discussed above, the network enabled architecture includes components: a NetRouter and NetObject. Even though a network object, or NetObject, is conceptually similar to an object from object-oriented programming, a less rigorous concept of an object is used in the present invention. For instance, an object model of a device consists of fields, methods and events. In particular, fields corresponds to the internal variables of the device; methods are the functions that the device will export (i.e., allow us to remotely invoke using commands sent over a network such as the Internet); and events are like software or hardware interrupts in traditional embedded systems. Events can be published, and one or more subscribers can receive notification of their occurrence.

One NetObject can communicate with another NetObject by getting and setting public fields, running public methods, and subscribing/publishing to one another's events. Similarly, the public properties, methods and events of a NetObject can be accessed from software programs written in C/C++, Visual Basic, Java, or any other language that supports network communications.

A NetRouter typically runs on a computer, or any other Java-enabled platform, and acts as an intermediary or translator between one NetObject and another. NetRouters can also communicate securely with each other over a TCP/IP network. The NetRouter components includes a routing engine, which includes Network drivers (NetDrivers) for both standard and custom protocols over multiple physical networks, Web/App server (NetServer), JDBC/ODBC gateway, SMTP/POP3 gateway, and/or Time server (NetTimeServer).

For new devices, the NetObject software runs in the device itself and can communicate over a lightweight network with a NetDriver using the NetEnabled protocols. For legacy systems that have an existing protocol, the NetDriver layer allows for a level of indirection, serving to abstract a proprietary protocol to a common messaging format. FIG. 9 shows how a NetRouter and NetObject interact with each other. NetDrivers are also called adapter, because they are used to adapt signals generated by legacy devices into a common messaging format, and thus “adapt” the legacy object into a device compatible with a NetConnect system.

Virtually all system activity is initiated by either the occurrence of an event or the invocation of a method on a NetObject. Events can be generated in response to real events (e.g., a button press on an X-10 minicontroller) or software events (e.g., a TimeServer generates a one-minute tick or a WebServer receives a request for a web page). These events are then “published”. Recipients “subscribe” to the event and perform an action specified by their control software when the subscribed-to event occurs.

Each device must have a well-defined communications interface (e.g., RS-232, RS-485, CAN). To implement the invention, each device must be “described” as (i.e., represented by) an object (i.e., in terms of its fields, methods and events). A skeleton NetDriver is generated from this description, and then NetDriver code is written to implement communications to be supported by the object.

When a client is not compatible with the X-10 protocol, an X10 to RS-232 converter, such as a Two-Way TW-523 adapter, may be used. The X-10 system is “Internet-enabled” using the software of the present invention.

An object model of the device X-10 commands preferably includes a house code (A-P) followed by either a unit code (1-16) or a function code (on, off, etc.). To send an ON command to module A1, the “A1” string is followed by an “AON” string.

In general, X-10 modules support sixteen different functions (though not all modules support all functions). The most frequently used functions, and their Two-Way codes, are shown in Table 1.)

An X-10 module is a NetObject, and the NetDriver acts like a proxy—exposing the NetObject's methods to the network enabled system. A Two-Way adapter acts like a translator—it speaks X-10 on a power line and speaks ASCII on a serial port.

Implementation of the ON and OFF functionality is described here. Creating an object model consists of writing an Interface Definition File, which is a file that describes a device's fields, methods and events. An Interface Definition File listing can also include information about the vendor, where additional information may be found and so on. Listing 1 shows a basic Interface Definition File for this device. Note that there is an extra method called sendString( ). The sendString which has been added to show a method that takes a parameter, since on( ) and off ( ) are both parameter-less.

Once the Interface Definition File representation of the device is created, the next step is to create a device-specific NetDriver. The NetDriver converts between the NetEnabled™ messaging format and an application-specific messaging format.

Much of the process of creating a NetDriver can be automated. Using the interface definition file just created, and the ncmgen.exe utility supplied with NetEnabled software, both an XML description of a device and a skeleton NetDriver Java file can be generated. Listing 2 shows an example of NetDriver skeleton code for the interface definition file in Listing 1.

Note that the Two Way NetDriver class extends SerialNetDriver. The SerialNetDriver class contains code to ran as a thread, create iostreams to the serial port, queue messages and perform other necessary system and utility functions. Since the Two WayNetDriver class extends the SerialNetDriver class, it inherits all of these properties and methods, and can overwrite them.

Next, code needs to be added to the TwoWayNetDriver.java file to implement the communications between it and the TwoWay translator device. The revised NetDriver program is discussed next, and is shown in Listing 3. The computer communicates with the TwoWay device the serial port via three-character messages, followed by a <CR>. The first character is the house code, followed by either a two digit representation of the unit code (01-16) or a function code.

For example, to turn on X-10 module C1, a device would send the following string: “C01\rCON\r”. The Two-Way module typically responds with a 4-character message followed by a <CR>. The possible codes for the first character, and the rest of the message, are summarized in Table 2.

Further information on the X-10 is provided in Two-Way™ Owner's Manual.

To summarize, the operation of the Two-Way module is as follows: (A) messages originating on the RS-232-side of Two-Way are interpreted and passed on to the X-10 interface if they are correct, or returned to the RS-232 interface if they are incorrect, per Table 2; and (B) messages originating on the X-10 interface (including messages just created by the Two-Way unit itself) are delivered to the RS-232 interface, per Table 2.

To finish the NetDriver, the appropriate serial port settings are selected in the init( ), off( ) and sendstring( ) methods, and an event handler is implemented for the incoming packets of data.

The SerialNet Driver class has an OutputStream object, os whose write( ) method can be used to write bytes to the serial port.

The SerialNetDriver class also has the receivedBytes( ) method which is called whenever characters are received from the serial port.

The os.write ( ) method can be used to send messages of the form “C01r” and “CON\r” over the serial port. The processBytesRcvd( ) method can be overridden to handle messages of the form “!C01\r” and “!CONr”, which are received from the Two-Way system.

In this example, the X-10 mini-controller generates an “on” or “off” event. The Two-Way module reads the event from the power-line and passes it onto the NetDriver, which then converts the event to the NetEnabled message format and sends it to the NetRouter for publication.

The final piece of the NetEnabled X10 system is custom application code. This module subscribes to events generated by the TwoWayNetDriver, and forwards them onto another TwoWayNetDriver running on a remote system, enabling one X- 10 system running in the user's house to control X-10 modules on a different X-10 system, running anywhere in the world.

The X-10 can then be accessed, controlled, configured and managed over the Internet through a web browser. Countless other devices will communicate with each other, and the corporate databases, ERP packages, billing systems and other business applications that are at the core of current enterprise data. Many of these applications will not be browser-based, even though they are using the Internet.

For the present invention, there may be any number of user interfaces, like the command-line utility in Listing 4.

The following command would execute the sendstring( ) method of the NetObject with an ID of 88888, with an argument of “A01”:

nmi.exe 127.0.0.1 88888 sendString A01

Now, consider using an actual X-10 mini-controller as a user interface-except that the X-10 mini-controller can be anywhere. Normally, an X-10 mini-controller and an X-10 module would be on the same power line (typically within a house). Two, or more, different houses can have the X-10 system so far discussed, each with its own X10 system, bridged with the NetEnabled software. That way, a mini-controller in one house could control an air conditioner module in the other house. In order to accomplishing this bridging″ of two X-10 systems, a custom application is written.

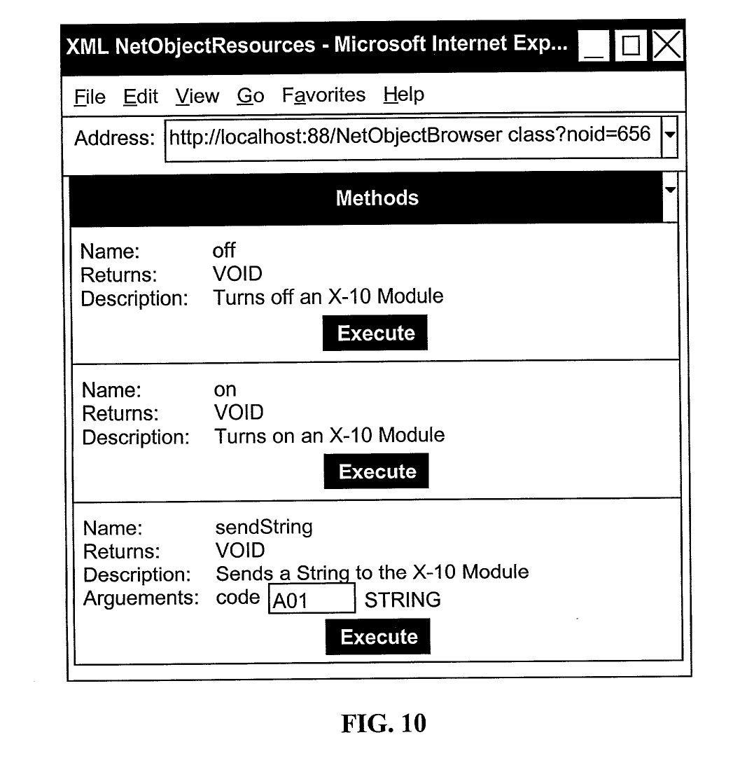

For the user interface, the web browser is discussed. One of the components of the NetRouter is a web server (NetServer) which can parse a device's XML description (which was created earlier) and auto-generate an HTML-based user interface. FIG. 10 shows the auto-generated user interface created by the NetObjectBrowser component of the NetServer.

A second example demonstrates the process of Internet-enabling an existing device using the SV200 Servo Motor Controller manufactured by Pontech of Brea, Calif. The SV200 is a P1C 16C73 microcontroller-based servo motor controller board that accepts RS-232 serial data from a host computer and outputs PWM (pulse-width-modulated) data.

The following is a brief discussion on the SV200 device and its Interface signals to control up to eight RC servo motors. Unused servo pins may be reconfigured as digital outputs for controlling on/off devices. LED displays can be driven directly by the SV200, but devices such as relays and solenoids may need a simple transistor driver circuit. The SV200 also includes a five-channel A/D port for reading analog voltage between 0 and 5 volts, and an SPI (synchronous peripheral interface) port which allows data to be shifted in or out serially.

The SV200 which processes information one ASCII string command at a time. Each command follows the format:

LnLn . . . <enter>

(maximum of 80 characters)

were L is the command letter(s) in caps, n is a decimal integer number(s), and <enter> is ASCII code 13. For example, the command to select a board, select a servo and move to a position are BD, SV, and M, respectively. To move servo number 3 of a board with an ID number equal to 1 to a position of 85, the following command string could be sent: “BD1 SV3 M85 <enter>”.

In addition to the previous command string, the following commands are also valid:

BD1 SV3 M85 <enter>

or

BD1, SV3, M85 <enter>

or

BD1 SV3 M85 <enter>

A terminal program may be used to test the functions of the board. The default setting on the board is preferably 9600 baud, N-8-1, with flow control and echo turned off. Once a board is selected, it will stay selected until power is removed, or another select command is received. Any command or parameter value not in the range of the command will be ignored. The board will start processing the command string when it sees the <enter> or the ASCII 13 character. The host computer talking to the board inserts a delay of about 3 milliseconds long between each command string to give it time to process the commands.

The next step in NetEnabling a product is to model the device or application as a Java object. The methods of the object preferably encapsulate the SV200's command set (Table 3). A set of methods that one might choose to encapsulate the SV200's functionality is shown in Listing 5.

For the sake of brevity, one single command, moveServoAbs(), is implemented. The remainder of the commands can be implemented in a similar manner. One possible implementation for moveServoAbs( ) is illustrated in Listing 6.

The outputStream object, i.e., outputStream write (cmd. getBytes ( )), is actually an output stream connected to the serial port Sun recently introduced their standard eXtensions (javax. * classes) to the core Java language (java. * classes), including a communications API (javax. comm. *, available on the web at: http://java.sun.com/products/javacomm/index.html) that allows platform-neutral access to serial and parallel ports. The declaration, instantiation and initialization of the output stream occur elsewhere in the Java object representing the device or application. The next section describes what is involved in connecting the moveServoAbs ( ) to the NetConnect system and serial port. The application or device to be NetEnabled is preferably represented as an object with a well-defined interface.

To finish NetEnabling an existing embedded device, an application-specific NetDriver is written. The NetDriver converts between the NetConnect messaging format and the application-specific messaging format. Fortunately, for most application, most of the work is already done. The remaining steps are:

Calling the super ( ) method in the constructor

Overriding protected void init( )

Overriding protected void processMessage(Message msg)

It is possible to automatically generate the processMessage( ) method from a Java code encapsulating its class's implementation methods using ncmgen.exe. A generic NetDriver implementing a very basic level of functionality is shown in Listing 7. The full implementation of the NetDriver for moveServoAbs ( ) is shown in Listing 8.

### Client, Server and Legacy Systems

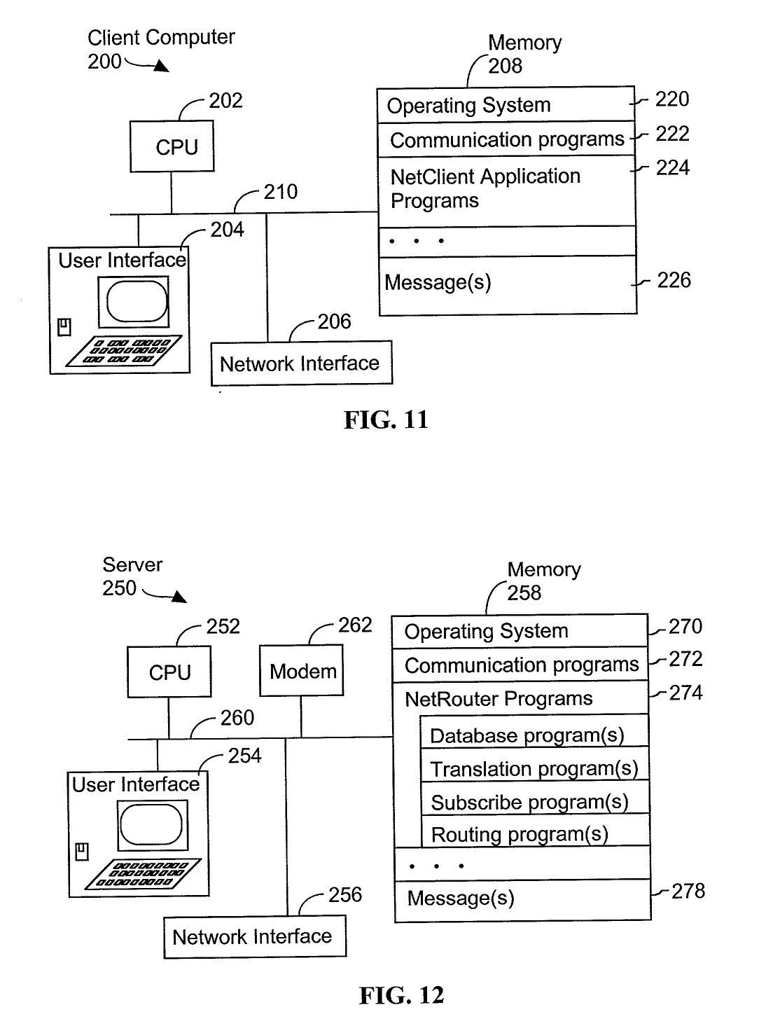

Referring to FIG. 11, a client computer or device 200 that incorporates a NetClient 102 will typically include one or more central processing units 202, a user interface 204, a network interface 206 for communicating with servers and other devices via a communication network such as the Internet, memory 208, and one or more system busses 210 interconnecting these components. Memory 208, which may include both high speed random access memory as well as non-volatile memory such as disk memory, typically stores programs and data such as:

an operating system 220 for performing basic system functions;

communication programs 222 for handling communications via the network interface 106;

one or more NetClient application programs 102, such as accounting programs and other programs that may be used to remotely control legacy devices; and

messages 226, such as messages sent by the client computer to legacy devices and vice versa.

Referring to FIG. 12, a server computer 250 used to implement a NetRouter 106 will typically include one or more central processing units 252, a user interface 254, a network interface 256 for communicating with client computers and other devices via a communication network such as the Internet, memory 258, one more modems 262, and one or more system busses 260 interconnecting these components. Memory 258, which may include both high speed random access memory as well as non-volatile memory such as disk memory, typically stores programs and data such as:

an operating system 270 for performing basic system functions;

communication programs 272 for handling communications via the network interface 256 and modem(s) 262;

NetRouter programs 274, typically including database programs, subscriber programs enabling NetObjects and NetClients to subscribe to events published by other NetObjects and NetClients, protocol translation programs for translating messages between protocols (i.e., between a common protocol used by the NetRouters and the various respective protocols used by the respective NetObjects and NetClients), and routing programs for routing translated messages to their destination (e.g., to the NetObjects and NetClients that have subscribed to the event represented by a particular message); and

messages 278, such as messages sent by NetObjects (e.g., in legacy devices) to NetClients (in client computers or devices) or other NetObjects, and vice versa.

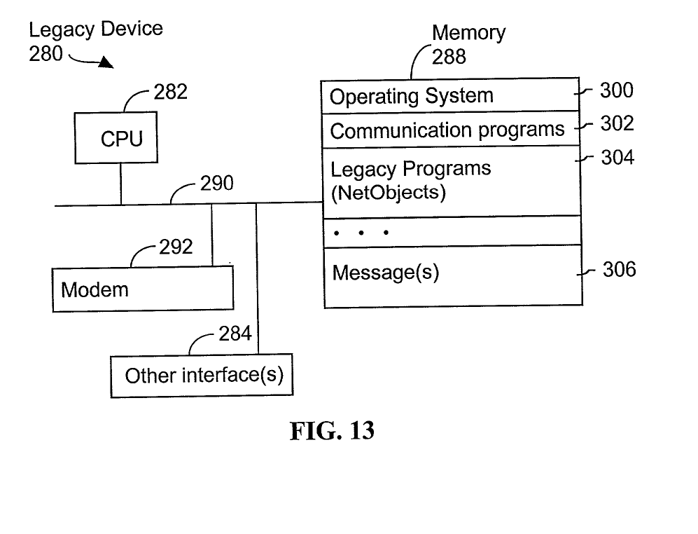

Referring to FIG. 13, a typical legacy device that incorporates a NetObject 108 includes one or more central processing units 282, interfaces 284 for communicating with or controlling various components of the legacy device, a modem 292 for communicating with servers and other devices via the PSTN or other network, memory 288, and one or more system busses 290 interconnecting these components. Memory 288, which may include both high speed random access memory as well as non-volatile memory such as ROM, flash or disk memory, typically stores programs and data such as:

an operating system 300 for performing basic system functions (although some legacy devices may not include an operating system);

communication programs 302 for handling communications via the modem 292;

legacy programs 304, for controlling or operating the legacy device and/or for retrieving status information about the legacy device, and which thus implement a NetObject; and

messages 306, such as messages sent by a client computer or device to the legacy device 280 and vice versa.

### EXAMPLES

Another example of the present invention is an Internet refrigerator which combines a standard refrigerator, a standard temperature transducer, a dedicated microprocessor, and a computer capable of supporting the HTTP protocol to produce a device which notifies people all over the world of the temperature of that a particular refrigerator. Here machines and programs have been combined to produce a new machine that has additional, and more importantly, global capabilities.

Other examples include linking game controllers, keyboards, speech recognition hardware, or other programs, to machines and programs that have been aggregated into network entities, to produce a complete end to end system of command, communication, and control.

Yet another example of the present invention is a municipal power grid that provides electrical service to private and corporate customers through a series of transformers and power lines that terminate on one end at power generation facilities and at the other end in an electrical power meter.

In the power grid system, each power meter a machine designed to monitor the power flowing to the customer and to record that usage for later reading by power company personnel. First, each meter is equipped with an adapter which converts the information produced by the meter (power usage over time) into a network neutral format. Second, the adapters for a related set of meters (perhaps all the meters on customers attached to a particular electrical substation) would then be configured to send their information to a super-adapter which is referred to as a NetRouter. Third, the super-adapter may process that information or may simply aggregate it, depending on the application. Finally, the set of NetRouters are then configured to be known to an information processing application such as a spreadsheet application while the meter might have a mechanical adapter, the spreadsheet would be equipped with a software adapter that converted from the network neutral form of the data to a form that the spreadsheet could display.

Another adapter can be provided to convert the information output of a rotary potentiometer to network neutral form. This adapter would feed its information into the NetRouter as well.

Computer programs can then be written in an architecture neutral language such as Java that combine the information of the potentiometer and the spreadsheet data, and convert this information into command information that is then forwarded back to the adapters located on the meters. Commands to the meters might be of the form “turn off power for three seconds” (or any other predetermined or computed length of time) or “send billing information by telephone” or “sound an alert device”.

By applying the invention to a historically passive network such as a municipal power grid, the grid has been converted into an active management device where the utility has pin point control over the information gathered and about power usage of all the customers in the grid.

In other words, the present invention combines existing devices (power meters), off the shelf software (spread sheets), and off the shelf hardware (game controllers) into a complete command, control, and management system.

In summary, a preferred embodiment the invention includes of a system composed of purpose built devices (generally microcontrollers) that have been adapted into a common network architecture neutral framework (this process is called “network enabling” the device), aggregated by a hierarchy of software engines that provide both connectivity and semantic translation called network routers. The network routers are then connected through the network architecture neutral command and control programs or devices to provide a complete system of Internet worked and distributed devices operating toward a common goal.

Al though the preferred embodiments of the invention have been described in the foregoing description, it will be understood that the present invention is not limited to a water heating mechanism in a coffee brewer. It should be understood that the materials used and the mechanical detail maybe slightly different or modified from the description herein without departing from the methods and composition disclosed and taught by the present invention as recited in the claims.

LISTING 1
Two Way Net Driver.idf *** The Interface Definition File

<NETOBJECT>

<METHOD>

<NAME>off</NAME><RETURNS>VOID</RETURNS>
<DESC>Turns off an X-10 Module.</DESC>

</METHOD>
<METHOD>

<NAME>on</NAME><RETURNS>VOID</RETURNS>
<DESC>Turns on an X-10 Module.</DESC>

</METHOD>
<METHOD>

<NAME>sendString</NAME><RETURNS

>VOID</RETURNS>

<DESC>Sends a String to the X-10 powerline.</DESC>
<PARAM>

<NAME>code</NAME>
<TYPE>STRING</TYPE>
<DESC>The String to send over the powerline.</DESC>

</PARAM>

</METHOD>
<EVENT>

<NAME>off</NAME><TYPE>BOOLEAN</TYPE>
<DESC>X-10 Module Turned Off.</DESC>

</EVENT>
<EVENT>

<NAME>on</NAME><TYPE>BOOLEAN</TYPE>
<DESC>X-10 Module Turned ON.</DESC>

</EVENT>

</NETOBJECT>

LISTING 2
TwoWayNetDriver.java - The auto-generated Java file

class TwoWayNetDriver extends SerialNetDriver {

public Two WayNetDriver(RoutingEngine re) {

super(re);
//TODO: Adjust Settings for your application
baud = 9600;
bits = SerialPort.DATABITS_8;
stop = SerialPort.STOPBITS_1;
parity = SerialPort.PARITY_NONE;

}
protected void init()

//TODO: Add initialization code

}
/**
* Turns off an X-10 Module.
*/
public void off() {

//TODO: Add method body

}
/**
* Turns on an X-10 Module.
*/
public void off() {

//TODO: Add method body

}
/**
* Sends a String to the X-10 powerline.
* param code The String to send over the powerline.
*/
public void sendString(String code) {

//TODO: Add method body

}
// MACHINE GENERATED CODE: DO NOT MODIFY
// {{BEGIN NCM_MESSAGE_MAP
protected void processNetMessage(NetMessage nm) {

switch(nm.getMessageType()) {
case nm.NMI:

nm.readShort ();
switch (nm.readShort()) {
case 0×4100:

off();
break();

case 0×4101:

on();
break ();

}
case 0×4102:

sendString();
break();

}

}

}
// }}END NCM_MESSAGE_MAP

}

LISTING 3
Changes to TwoWayNetDriver.java

class TwoWayNetDriver extends SerialNetDriver {

private String response = “”;
public TwoWayNetDriver(RoutingEngine re) {

super(re);
baud = 2400;

bits = SerialPort.DATABITS_8;
stop = Serialport.STOPBITS_2;
parity = SerialPort.PARITY_NONE;

}
public synchronized void off() {

// Get the X-10 address for this NetObject ID
String code = routingEngine.netToPhy(noid);
try {

os.write(code + “/r”);

}
catch(IOException e) {

// Error

}
try {

java.lang.Thread.sleep(500L);

}
catch(InterruptedException e) {}
try {
os.write(code.charAt(0) + “OF” + “\r”);
}
catch(IOException e) {

// Error

}

}
public synchronized void sendString(String code) {

try {

os.write(code);

}
catch(IOException e) {

// Error

}
try {

java.lang.Thread.sleep(500L);

}
catch(InterruptedException e) {}
}
public void processBytesRcvd(byte[] bytes) {

String str = new String(bytes);
if{str.startsWith(“!”)) {

// Get rest of message.
// Decode Message.
// Send to RoutingEngine (which will publish it)

}

}

}

LISTING 4
Usage info for nmi.exe

| | |
|---|---|
| nmi.exe | IP Address |
| | NetObjectID |
| | Method Name |
| | [Args (CSV)] |

LISTING 5
Methods encapsulating the SV200's functionality

void moveServoAbs (byte board, byte servo, byte value)
void moveServoAbs (byte board, byte servo, byte value)
byte getAnalog (byte board, byte port)
void shiftInSPI (byte board)
void shiftOutSPI (byte board, byte value)
void setDelay (byte board u_short value)
void setPin (byte board, byte pin)
void clearPin (byte board, byte pin)
void togglePin (byte board, byte pin)
byte readRAM (byte board, byte location)
void writeRAM (byte board, byte location, byte value)
void readEEPROM (byte board, short location)
void writeEEPROM (byte board, short location, byte value)

LISTING 6
The Implementation of moveServoAbs ()

void moveServoAbs (byte board, byte servo, byte value)
{

String cmd;
if( (servo >= 1) && (servo <= 8)) //Verify that servo in [1..8]
{

cmd = “BD” + board + “SV” + servo + “M” + value + “\r”;
try
{

outputStream.write(cmd.getBytes());

}
catch (IOException e)
{

// Error

}

else
{

System.out.print (“Invalid Parameters: ”);
System.out.print (“Servo: Expected [1:8]: Received: “+ servo);
System.out.print (“Message Dropped\n”);

}

}

LISTING 7
The Skeleton Implementation of a NetDriver

class myApp extends NetDriver
{

public myApp(RoutingEngine re)
{

super(re);
init();

}
protected void init()
{

System.out.println(“init()”);

}
protected void processMessage(Message msg)
{

System.out.println(“processMessage()”);
msg.debug();

}

}

LISTING 8
Implementation of the Sv200 NetDriver class

import java.io.*;
import java.util.*;
import javax.comm.*;
class Sv200 extends NetDriver
{

static Enumeration portList;
static CommPortIdentifier portId;
static SerialPort serialPort;
static OutputStream outputStream;
public Sv200(RoutingEngine re)
{

super(re);
init();

}
protected void init()
{
portList = CommPortIdentifier.getPortIdentifiers();
while (portList.hasMoreElements())
{

portId = (CommPortIdentifier) portList.nextElement();
if (portId.getPortType() ═

CommPortIdentifer.PORT_SERIAL)

{

if(portId.getName().equals(“COM1”))
{

try
{

serialPort = (SerialPort)

portId.open(“Sv200), 2000);

}
catch (PortInUseException e)
{

// Fatal Error

}
try
{

outputStream = serialPort.getOutputStream();

}
catch (IOException e)
{

// Fatal Error

}
try
{

serialPort.setSerialPortParams(9600,
SerialPort.DATABITS_8,
SerialPort.STOPBITS_1,
SerialPort.PARITY_NONE);

}
catch (UnsupportedCommOperationException e)
{

// Fatal Error

}

}

}

}

}
private void moveServoAbs (byte board, byte servo, byte value)
{

String cmd;
if( (servo >= 1) && (servo <= 8) )
{

cmd = “BD” + board + “SV” + servo + “M” + value + “\r”;
try
{

outputStream.write(cmd.getBytes());

}

catch (IOException e)
{

// Error

}

}
else
{

System.out.print(“Invalid Parameters: “);
System.out.print(“Servo: Expected [1:8]:

Received: “+ servo);

System.out.print (“Message Dropped\n”);

}

}
// {{BEGIN NCM_MESSAGE_MAP
protected void processMessage (Message msg)
{

switch (msg.getMessageType())
{
case msg.RUN:

msg.readShort();
switch(msg.readShort())
{
case 0×4100:

moveServoAbs(msg.readByte(), msg.readByte(),

msg.readByte());

break;

}

}

}
// }}END NCM_MESSAGE_MAP

}

TABLE 1
X-10 Functions

| Function | Code |
|---|---|
| All Units Off | A0 |
| All Lights On | L1 |
| On | ON |
| Off | OF |
| Dim | DI |
| Bright | BR |

TABLE 2
Two-Way Response Codes

| Code | Meaning |
|---|---|
| ! | Valid message read from powerline. The 3- |
| | character message follows the “!” |
| ? | Invalid message sent from computer. The |
| | invalid 3-character message follows the “?” |
| > | The characters that follow did not originate |
| | from the powerline. This code typically |
| | indicates an error. |

TABLE 3
The complete command listing for the SV200

| Commands | Parameter | Description |
|---|---|---|
| BDn | 0:255 | Board Select |
| SVn | 1:8 | Servo Select |
| Mn | 0:255 | Move to an absolute location |
| In | −128:127 | Move relative to a current position |
| Dn | 1:65535 | Delay (ins) |
| PSn | 1:8 | Pin Set |
| PCn | 1:8 | Pin Clear |
| PTn | 1:8 | Pin Toggle |
| AD n | 1:5 | Get A/D value. The board returns a value |
| | | (0:255) followed by ASCII 13. The return |
| | | value maps to a range of 0-5 volts. |
| SOn | 0:255 | Shift byte out of SPI port |
| SI | — | Shift byte into SPI port |
| WRm n | m: = 0:255 | Write the value n to memory |
| | n: = 0:255 | location m in RAM |
| RRm | 0:255 | Read the value of memory location m |
| | | in RAM |
| WEm n | m: = 0:8190 | Write the value n to |
| | n: = 0:255 | memory location m in EEPROM |
| REm | 0:8190 | Read the value of memory location |
| | | m in EEPROM |
| ? | — | Help returns a summary of the command |
| | | listing |

what is claimed is:

1. A distributed computer system comprising:
a plurality of first entities configured to generate a plurality of first messages in a first communication protocol;
a first adapter configured to convert the first messages of the first protocol to a second communication protocol;
a second entity coupled to the first entities and configured to communicate therewith via the first adapter; and
a third entity configured to receive the first messages from the first entities, configured to generate a second message based on the received first messages.

2. The system of claim 1 wherein the second entity is coupled to the first entities via a public switched telephone network.

3. The system of claim 1 wherein the second entity is coupled to the first entities via the Internet.

4. The system of claim 1 wherein the third entity is further configured to forward the second message to at least one of the first entities via the second entity.

5. The system of claim 1 wherein the third entity includes a set of computer executable instructions for determining a course of action to be taken by one of the first entities based on the first messages.

6. The system of claim 5 wherein the course of action is to turn off one of the first entities for a predetermined time period.

7. The system of claim 1 wherein the third entity is a spreadsheet program.

8. The system of claim 1, wherein the adapter and the second entity are embodied in a server that is coupled to the third entity via the Internet.

9. The system of claim 1, wherein the adapter and the second entity are embodied in a computer that is coupled to the third entity via a communications network.

10. The system of claim 1, wherein the second entity includes a subscriber program for subscribing the third entity to specified event messages of the first messages, and a router program for routing to the third entity the event messages to which the third entity has subscribed via the subscriber program.

11. A distributed computer system comprising:
a plurality of first entities configured to generate a plurality of first messages in a plurality of first communication protocols;
a plurality of adapters configured to convert the first messages of the first communication protocols to a second, common communication protocols;
a second entity coupled to the first entities and configured to communicate therewith via the plurality of adapters; and
a plurality of third entities, remotely located from the second entity, configured to receive the first messages from the first entities, and configured to generate second messages based on the received first messages, the plurality of third entities coupled to the second entity via one or more communication networks;
wherein the second entity includes a subscriber program for subscribing respective entities of the third entities to specified event messages of the first messages, and a router program for routing to the respective third entities the event messages to which the respective third entities have subscribed via the subscriber program.

12. The system of claim 11 wherein at least one of the third entities is coupled to the second entity via the Internet.

13. The system of claim 11 wherein at least one of the third entities is further configured to forward one of the second messages to at least one of the first entities via the second entity.

14. The system of claim 11 wherein one of the third entities includes a set of computer executable instructions for determining a course of action to be taken by one of the first entities based on at least one of the first messages.
